(19) United States
(12) Patent Application Publication
(10) Pub. No.: US 2018/0357073 A1
(43) Pub. Date: Dec. 13, 2018

(54) METHOD, DEVICE, AND SYSTEM FOR ELECTRONIC DIGITAL ASSISTANT FOR NATURAL LANGUAGE DETECTION OF A USER STATUS CHANGE AND CORRESPONDING MODIFICATION OF A USER INTERFACE

(71) Applicant: MOTOROLA SOLUTIONS, INC, Chicago, IL (US)

(72) Inventors: ERIC JOHNSON, CHICAGO, IL (US); CRAIG SIDDOWAY, DAVIE, FL (US); JARI P. JARVINEN, CORAL SPRINGS, FL (US); RYAN M. NILSEN, PLANTATION, FL (US); BERT VAN DER ZAAG, WHEAT RIDGE, CO (US); CHI T. TRAN, WAUWATOSA, WI (US); ERIN B. BRYANT, SUNRISE, FL (US)

(21) Appl. No.: 15/621,387

(22) Filed: Jun. 13, 2017

(51) Int. Cl. G06F 9/44; G10L 15/22

(52) U.S. Cl. CPC G06F 9/4443; H04W 88/02; G10L 15/22

(57) ABSTRACT

A process at an electronic digital assistant (EDA) computing device uses natural language detection of a user status change to make corresponding modification of a user interface associated with the user. The EDA monitors a private or talkgroup voice call associated with a user and detects first user speech from the user. The EDA identifies a current status of the user of on-assignment or not-on-assignment and determines that the first user speech is indicative of a first or second user status change. When it is the first user status change, the EDA causes a mobile or portable computing device associated with the user to automatically swap a foreground not-on-assignment related application with a not-previously-in-foreground on-assignment related application, and vice versa when it is the second user status change.

### BACKGROUND OF THE INVENTION

Tablets, laptops, phones (e.g., cellular or satellite), mobile (vehicular) or portable (personal) two-way radios, and other communication devices are now in common use by users, such as first responders (including firemen, police officers, and paramedics, among others), and provide such users and others with instant access to increasingly valuable additional information and resources such as vehicle histories, arrest records, outstanding warrants, health information, real-time traffic or other situational status information, and any other information that may aid the user in making a more informed determination of an action to take or how to resolve a situation, among other possibilities.

Many such communication devices further comprise, or provide access to, electronic digital assistants (or sometimes referenced as “virtual partners”) that may provide the user thereof with valuable information in an automated (e.g., without further user input) or semi-automated (e.g., with some further user input) fashion. The valuable information provided to the user may be based on explicit requests for such information posed by the user via an input (e.g., such as a parsed natural language input or an electronic touch interface manipulation associated with an explicit request) in which the electronic digital assistant may reactively provide such requested valuable information, or may be based on some other set of one or more context or triggers in which the electronic digital assistant may proactively provide such valuable information to the user absent any explicit request from the user.

As some existing examples, electronic digital assistants such as Siri provided by Apple, Inc.® and Google Now provided by Google, Inc.®, are software applications running on underlying electronic hardware that are capable of understanding natural language, and may complete electronic tasks in response to user voice inputs, among other additional or alternative types of inputs. These electronic digital assistants may perform such tasks as taking and storing voice dictation for future reference and retrieval, reading a received text message or an e-mail message aloud, generating a text message or e-mail message reply, looking up requested phone numbers and initiating a phone call to a requested contact, generating calendar appointments and providing appointment reminders, warning users of nearby dangers such as traffic accidents or environmental hazards, and providing many other types of information in a reactive or proactive manner.

### BRIEF DESCRIPTION OF THE SEVERAL VIEWS OF THE DRAWINGS

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 is a system diagram illustrating a system for operating an electronic digital assistant, in accordance with some embodiments.

FIG. 2 is a device diagram showing a device structure of an electronic computing device for operating an electronic digital assistant, in accordance with some embodiments.

FIG. 3 illustrates a flowchart setting forth a first set of process steps for operating the electronic digital assistant of FIGS. 1 and/or 2, in accordance with some embodiments.

FIG. 4 illustrates a flowchart setting forth a second set of process steps for operating the electronic digital assistant of FIGS. 1 and/or 2, in accordance with some embodiments.

FIG. 5 illustrates a flowchart setting forth a third set of process steps for operating the electronic digital assistant of FIGS. 1 and/or 2, in accordance with some embodiments.

FIG. 6 illustrates a diagram setting forth a portable radio user interface transition commensurate with the description set forth in FIG. 4, in accordance with some embodiments.

FIG. 7 illustrates a diagram setting forth a mobile radio user interface transition commensurate with the description set forth in FIG. 5, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In many cases, the user must speak directly to an electronic digital assistant and request the electronic digital assistant to perform a particular task. Furthermore, officers in the field and other users, such as retail workers or transportation drivers, may be in a position in which they must keep the eyes up and/or hands down, and may have a limited ability to change a user interface of a portable or mobile computing device at their disposal.

Thus, there exists a need for an improved technical method, device, and system for an electronic digital assistant to detect a user's natural language speech transmissions to one or more other users, and to infer from that speech, and without requiring further manual interaction such as touch-screen or keyboard interaction, a change in assignment status that can be correspondingly applied to automatically modify a user interface of a mobile or portable device computing device at their disposal.

In one embodiment a process at an electronic digital assistant computing device for natural language detection of a user status change and corresponding modification of a user interface includes: monitoring, at an electronic computing device, one of a private voice call and a talkgroup voice call associated with an in-field user; detecting, by the electronic computing device over the one of the private voice call and the talkgroup voice call associated with the in-field user, first user speech from the in-field user; identifying, by the electronic computing device, a current status of the in-field user of one of an on-assignment related status and a not-on-assignment related status; determining, by the electronic computing device, that the first user speech is indicative of one of (i) a first status change of the in-field user in which the current status of the in-field user is the not-on-assignment related status and the first user speech is indicative of a change to the on-assignment related status and (ii) a second status change of the in-field user in which the current status of the in-field user is the on-assignment related status and the first user speech is indicative of a change to the not-on-assignment related status; and when the determining, by the electronic computing device, is that the first user speech is indicative of the first status change, responsively: causing, by the electronic computing device, one of a mobile and a portable computing device associated with the in-field user to automatically and responsively swap a foreground not-on-assignment related application with a not-previously-in-foreground on-assignment related application; and when the determining, by the electronic computing device, is that the first user speech is indicative of the second status change, responsively: causing, by the electronic computing device, one of the mobile and the portable computing device associated with the in-field user to automatically and responsively swap a foreground on-assignment related application with a not-previously-in-foreground not-on-assignment related application.

In a further embodiment, a computing device implementing an electronic digital assistant for natural language detection of a user status change and corresponding modification of a user interface includes a memory storing non-transitory computer-readable instructions; a transceiver; and one or more processors configured to, in response to executing the non-transitory computer-readable instructions, perform a first set of functions comprising: monitoring one of a private voice call and a talkgroup voice call associated with an in-field user; detect, over the one of the private voice call and the talkgroup voice call associated with the in-field user, first user speech from the in-field user; identify a current status of the in-field user of one of an on-assignment related status and a not-on-assignment related status; determine that the first user speech is indicative of one of (i) a first status change of the in-field user in which the current status of the in-field user is the not-on-assignment related status and the first user speech is indicative of a change to the on-assignment related status and (ii) a second status change of the in-field user in which the current status of the in-field user is the on-assignment related status and the first user speech is indicative of a change to the not-on-assignment related status; and when the determining is that the first user speech is indicative of the first status change, responsively: cause one of a mobile and a portable computing device associated with the in-field user to automatically and responsively swap a foreground not-on-assignment related application with a not-previously-in-foreground on-assignment related application; and when the determining is that the first user speech is indicative of the second status change, responsively: cause one of the mobile and the portable computing device associated with the in-field user to automatically and responsively swap a foreground on-assignment related application with a not-previously-in-foreground not-on-assignment related application.

Each of the above-mentioned embodiments will be discussed in more detail below, starting with example communication system and device architectures of the system in which the embodiments may be practiced, followed by an illustration of processing steps for achieving the method, device, and system for an electronic digital assistant. Further advantages and features consistent with this disclosure will be set forth in the following detailed description, with reference to the figures.

### 1. COMMUNICATION SYSTEM AND DEVICE STRUCTURES

a. Communication System Structure

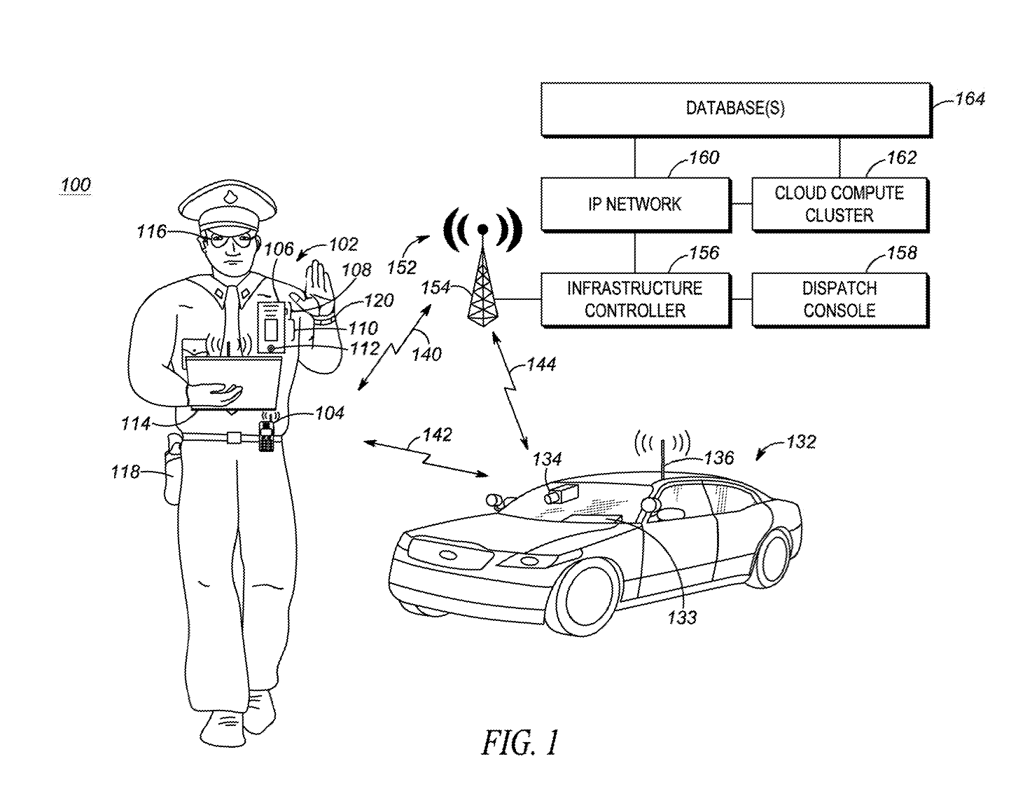

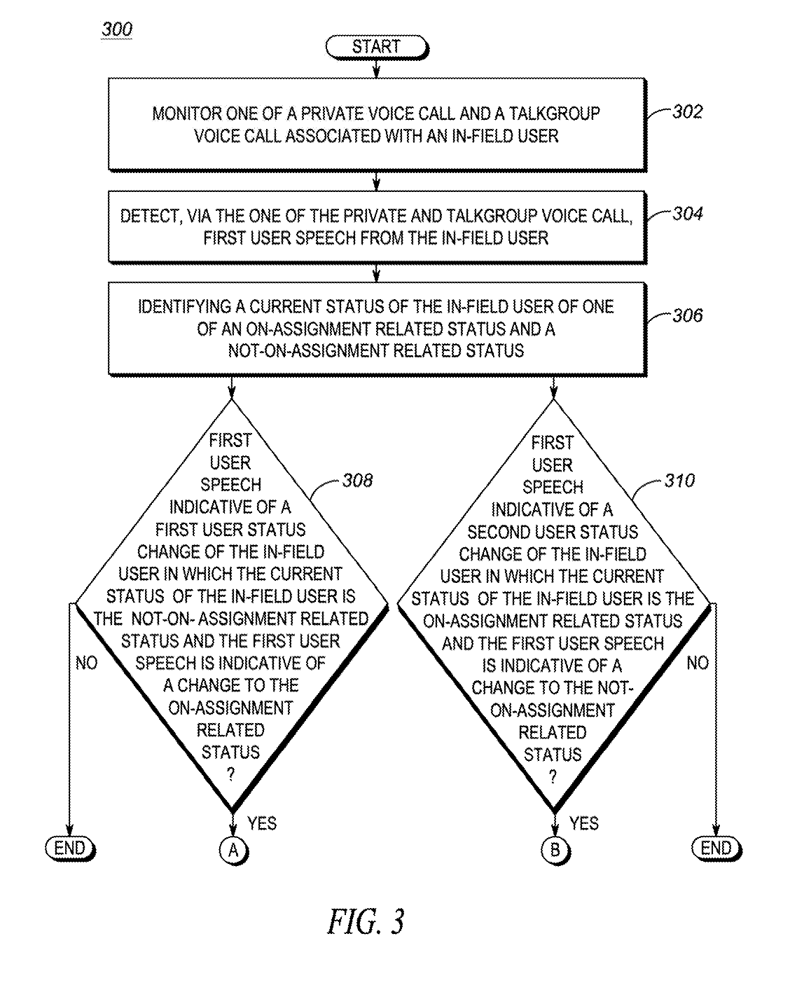

Referring now to the drawings, and in particular FIG. 1, a communication system diagram illustrates a system 100 of devices including a first set of devices that a user 102 (illustrated in FIG. 1 as a first responder police officer) may wear, such as a primary battery-powered portable radio 104 used for narrowband and/or broadband direct-mode or infrastructure communications, a battery-powered radio speaker microphone (RSM) video capture device 106, a laptop 114 having an integrated video camera and used for data applications such as incident support applications, smart glasses 116 (e.g., which may be virtual reality, augmented reality, or mixed reality glasses), sensor-enabled holster 118, and/or biometric sensor wristband 120. Although FIG. 1 illustrates only a single user 102 with a respective first set of devices, in other embodiments, the single user 102 may include additional sets of same or similar devices, and additional users may be present with respective additional sets of same or similar devices. Furthermore, the user 102 is identified and described herein as an ‘in-field user’ (hereinafter, ‘user’), in that the user 102 is in the field (e.g., on the clock and performing some portion of his or her duties) in a professional context, and may have either a specifically assigned (and higher priority) current task (e.g., on-assignment) or may be performing a general (and lower priority) activity or set of default tasks when no specifically assigned task is available and currently assigned (e.g., not-on-assignment). Further examples will be set forth below with respect to FIGS. 3-5.

System 100 may also include a vehicle 132 associated with the user 102 having an integrated mobile communication device 133, an associated vehicular video camera 134, and a coupled vehicular transceiver 136. Although FIG. 1 illustrates only a single vehicle 132 with a respective single vehicular video camera 134 and transceiver 136, in other embodiments, the vehicle 132 may include additional same or similar video cameras and/or transceivers, and additional vehicles may be present with respective additional sets of video cameras and/or transceivers.

Each of the portable radio 104, RSM video capture device 106, laptop 114, and vehicle 132 may be capable of directly wirelessly communicating via direct-mode wireless link(s) 142, and/or may be capable of wirelessly communicating via a wireless infrastructure radio access network (RAN) 152 over respective wireless link(s) 140, 144 and via corresponding transceiver circuits. These devices may be referred to as communication devices and are configured to receive inputs associated with the user 102 and/or provide outputs to the user 102 in addition to communicating information to and from other communication devices and the infrastructure RAN 152.

The portable radio 104, in particular, may be any communication device used for infrastructure RAN or direct-mode media (e.g., voice, audio, video, etc.) communication via a long-range wireless transmitter and/or transceiver that has a transmitter transmit range on the order of miles, e.g., 0.5-50 miles, or 3-20 miles (e.g., in comparison to a short-range transmitter such as a Bluetooth, Zigbee, or NFC transmitter) with other communication devices and/or the infrastructure RAN 152. The long-range transmitter may implement a direct-mode, conventional, or trunked land mobile radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, the long range transmitter may implement a Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application may be implemented. In still further embodiments, the long range transmitter may implement a Wi-Fi protocol perhaps in accordance with an IEEE 802.11 standard (e.g., 802.11a, 802.11b, 802.11g) or a WiMAX protocol perhaps operating in accordance with an IEEE 802.16 standard.

In the example of FIG. 1, the portable radio 104 may form the hub of communication connectivity for the user 102, through which other accessory devices, such as a biometric sensor (for example, the biometric sensor wristband 120), an activity tracker, a weapon status sensor (for example, the sensor-enabled holster 118), a heads-up-display (for example, the smart glasses 116), the RSM video capture device 106, and/or the laptop 114 may communicatively couple.

In order to communicate with and exchange video, audio, and other media and communications with the RSM video capture device 106 and/or the laptop 114, the portable radio 104 may contain one or more physical electronic ports (such as a USB port, an Ethernet port, an audio jack, etc.) for direct electronic coupling with the RSM video capture device 106 or laptop 114. In some embodiments, the portable radio 104 may contain a short-range transmitter (e.g., in comparison to the long-range transmitter such as a LMR or Broadband transmitter) and/or transceiver for wirelessly coupling with the RSM video capture device 106 or laptop 114. The short-range transmitter may be a Bluetooth, Zigbee, or NFC transmitter having a transmit range on the order of 0.01-100 meters, or 0.1-10 meters. In other embodiments, the RSM video capture device 106 and/or the laptop 114 may contain their own long-range transceivers and may communicate with one another and/or with the infrastructure RAN 152 or vehicular transceiver 136 directly without passing through portable radio 104.

The RSM video capture device 106 provides voice functionality features similar to a traditional RSM, including one or more of acting as a remote microphone that is closer to the user's 102 mouth, providing a remote speaker allowing playback of audio closer to the user's 102 ear, and including a PTT switch or other type of PTT input. The voice and/or audio recorded at the remote microphone may be provided to the portable radio 104 for storage and/or analysis or for further transmission to other mobile communication devices or the infrastructure RAN 152, or may be directly transmitted by the RSM video capture device 106 to other communication devices or from the infrastructure RAN 152. The voice and/or audio played back at the remote speaker may be received from the portable radio 104 or directly from one or more other communication devices or the infrastructure RAN. The RSM video capture device 106 may include a separate physical PTT switch 108 that functions, in cooperation with the portable radio 104 or on its own, to maintain the portable radio 104 and/or RSM video capture device 106 in a monitor only mode, and which switches the device(s) to a transmit-only mode (for half-duplex devices) or transmit and receive mode (for full-duplex devices) upon depression or activation of the PTT switch 108. The portable radio 104 and/or RSM video capture device 106 may form part of a group communications architecture that allows a single communication device to communicate with one or more group members (not shown) associated with a particular group of devices at a same time.

Additional features may be provided at the RSM video capture device 106 as well. For example, a display screen 110 may be provided for displaying images, video, and/or text to the user 102 or to someone else. The display screen 110 may be, for example, a liquid crystal display (LCD) screen or an organic light emitting display (OLED) display screen. In some embodiments, a touch sensitive input interface may be incorporated into the display screen 110 as well, allowing the user 102 to interact with content provided on the display screen 110. A soft PTT input may also be provided, for example, via such a touch interface.

A video camera 112 may also be provided at the RSM video capture device 106, integrating an ability to capture images and/or video and store the captured image data (for further analysis) or transmit the captured image data as an image or video stream to the portable radio 104 and/or to other communication devices or to the infrastructure RAN 152 directly. The video camera 112 and RSM remote microphone may be used, for example, for capturing audio and/or video of a suspect and the suspect's surroundings, storing the captured image and/or audio data for further analysis or transmitting the captured image and/or audio data as a video and/or audio stream to the portable radio 104 and/or to other communication devices or to the infrastructure RAN directly for further analysis. An RSM remote microphone of the RSM video capture device 106 may be a directional or unidirectional microphone or array of directional or unidirectional microphones that, in the case of directional or arrays of microphones, may be capable of identifying a direction from which a captured sound emanated.

The laptop 114, in particular, may be any wireless communication device used for infrastructure RAN or direct-mode media communication via a long-range or short-range wireless transmitter with other communication devices and/or the infrastructure RAN 152. The laptop 114 includes a display screen for displaying a user interface to an operating system and one or more applications running on the operating system, such as a broadband PTT communications application, a web browser application, a vehicle history database application, an arrest record database application, an outstanding warrant database application, a mapping and/or navigation application, a health information database application, or other types of applications that may require user interaction to operate. The laptop 114 display screen may be, for example, an LCD screen or an OLED display screen. In some embodiments, a touch sensitive input interface may be incorporated into the display screen as well, allowing the user 102 to interact with content provided on the display screen. A soft PTT input may also be provided, for example, via such a touch interface.

Front and/or rear-facing video cameras may also be provided at the laptop 114, integrating an ability to capture video and/or audio of the user 102 and the user's 102 surroundings, or a suspect (or potential suspect) and the suspect's surroundings, and store and/or otherwise process the captured video and/or audio for further analysis or transmit the captured video and/or audio as a video and/or audio stream to the portable radio 104, other communication devices, and/or the infrastructure RAN 152 for further analysis.

The smart glasses 116 may include a digital imaging device, an electronic processor, a short-range and/or long-range transceiver device, and/or a projecting device. The smart glasses 116 may maintain a bi-directional connection with the portable radio 104 and provide an always-on or on-demand video feed pointed in a direction of the user's 102 gaze via the digital imaging device, and/or may provide a personal display via the projection device integrated into the smart glasses 116 for displaying information such as text, images, or video received from the portable radio 104 or directly from the infrastructure RAN 152. In some embodiments, the smart glasses 116 may include its own long-range transceiver and may communicate with other communication devices and/or with the infrastructure RAN 152 or vehicular transceiver 136 directly without passing through portable radio 104. In some embodiments, an additional user interface mechanism such as a touch interface or gesture detection mechanism may be provided at the smart glasses 116 that allows the user 102 to interact with the display elements displayed on the smart glasses 116 or modify operation of the digital imaging device. In other embodiments, a display and input interface at the portable radio 104 may be provided for interacting with smart glasses 116 content and modifying operation of the digital imaging device, among other possibilities.

The smart glasses 116 may provide a virtual reality interface in which a computer-simulated reality electronically replicates an environment with which the user 102 may interact. In some embodiments, the smart glasses 116 may provide an augmented reality interface in which a direct or indirect view of real-world environments in which the user is currently disposed are augmented (i.e., supplemented, by additional computer-generated sensory input such as sound, video, images, graphics, GPS data, or other information). In still other embodiments, the smart glasses 116 may provide a mixed reality interface in which electronically generated objects are inserted in a direct or indirect view of real-world environments in a manner such that they may co-exist and interact in real time with the real-world environment and real world objects.

The sensor-enabled holster 118 may be an active (powered) or passive (non-powered) sensor that maintains and/or provides state information regarding a weapon or other item normally disposed within the user's 102 sensor-enabled holster 118. The sensor-enabled holster 118 may detect a change in state (presence to absence) and/or an action (removal) relative to the weapon normally disposed within the sensor-enabled holster 118. The detected change in state and/or action may be reported to the portable radio 104 via its short-range transceiver. In some embodiments, the sensor-enabled holster 118 may also detect whether the first responder's hand is resting on the weapon even if it has not yet been removed from the holster and provide such information to portable radio 104. Other possibilities exist as well.

The biometric sensor wristband 120 may be an electronic device for tracking an activity of the user 102 or a health status of the user 102, and may include one or more movement sensors (such as an accelerometer, magnetometer, and/or gyroscope) that may periodically or intermittently provide to the portable radio 104 indications of orientation, direction, steps, acceleration, and/or speed, and indications of health such as one or more of a captured heart rate, a captured breathing rate, and a captured body temperature of the user 102, perhaps accompanying other information. In some embodiments, the biometric sensor wristband 120 may include its own long-range transceiver and may communicate with other communication devices and/or with the infrastructure RAN 152 or vehicular transceiver 136 directly without passing through portable radio 104.

An accelerometer is a device that measures acceleration. Single and multi-axis models are available to detect magnitude and direction of the acceleration as a vector quantity, and may be used to sense orientation, acceleration, vibration shock, and falling. A gyroscope is a device for measuring or maintaining orientation, based on the principles of conservation of angular momentum. One type of gyroscope, a microelectromechanical system (MEMS) based gyroscope, uses lithographically constructed versions of one or more of a tuning fork, a vibrating wheel, or resonant solid to measure orientation. Other types of gyroscopes could be used as well. A magnetometer is a device used to measure the strength and/or direction of the magnetic field in the vicinity of the device, and may be used to determine a direction in which a person or device is facing.

The heart rate sensor may use electrical contacts with the skin to monitor an electrocardiography (EKG) signal of its wearer, or may use infrared light and imaging device to optically detect a pulse rate of its wearer, among other possibilities.

A breathing rate sensor may be integrated within the sensor wristband 120 itself, or disposed separately and communicate with the sensor wristband 120 via a short range wireless or wired connection. The breathing rate sensor may include use of a differential capacitive circuits or capacitive transducers to measure chest displacement and thus breathing rates. In other embodiments, a breathing sensor may monitor a periodicity of mouth and/or nose-exhaled air (e.g., using a humidity sensor, temperature sensor, capnometer or spirometer) to detect a respiration rate. Other possibilities exist as well.

A body temperature sensor may include an electronic digital or analog sensor that measures a skin temperature using, for example, a negative temperature coefficient (NTC) thermistor or a resistive temperature detector (RTD), may include an infrared thermal scanner module, and/or may include an ingestible temperature sensor that transmits an internally measured body temperature via a short range wireless connection, among other possibilities.

Although the biometric sensor wristband 120 is shown in FIG. 1 as a bracelet worn around the wrist, in other examples, the biometric sensor wristband 120 may additionally and/or alternatively be worn around another part of the body, or may take a different physical form including an earring, a finger ring, a necklace, a glove, a belt, or some other type of wearable, ingestible, or insertable form factor.

The portable radio 104, RSM video capture device 106, laptop 114, smart glasses 116, sensor-enabled holster 118, and/or biometric sensor wristband 120 may form a personal area network (PAN) via corresponding short-range PAN transceivers, which may be based on a Bluetooth, Zigbee, or other short-range wireless protocol having a transmission range on the order of meters, tens of meters, or hundreds of meters.

The portable radio 104 and/or RSM video capture device 106 (or any other electronic device in FIG. 1, for that matter) may each include a location determination device integrated with or separately disposed in the portable radio 104 and/or RSM 106 and/or in respective receivers, transmitters, or transceivers of the portable radio 104 and RSM 106 for determining a location of the portable radio 104 and RSM 106. The location determination device may be, for example, a global positioning system (GPS) receiver or wireless triangulation logic using a wireless receiver or transceiver and a plurality of wireless signals received at the wireless receiver or transceiver from different locations, among other possibilities. The location determination device may also include an orientation sensor for determining an orientation that the device is facing. Each orientation sensor may include a gyroscope and/or a magnetometer. Other types of orientation sensors could be used as well. The location may then be stored locally or transmitted via the transmitter or transceiver to other communication devices.

The vehicle 132 associated with the user 102 may include the mobile communication device 133, the vehicular video camera 134, and the vehicular transceiver 136, all of which may be coupled to one another via a wired and/or wireless vehicle area network (VAN), perhaps along with other sensors physically or communicatively coupled to the vehicle 132. The vehicular transceiver 136 may include a long-range transceiver for directly wirelessly communicating with communication devices such as the portable radio 104, the RSM 106, and the laptop 114 via wireless link(s) 142 and/or for wirelessly communicating with the RAN 152 via wireless link(s) 144. The vehicular transceiver 136 may further include a short-range wireless transceiver or wired transceiver for communicatively coupling between the mobile communication device 133 and/or the vehicular video camera 134 in the VAN. The mobile communication device 133 may, in some embodiments, include the vehicular transceiver 136 and/or the vehicular video camera 134 integrated therewith, and may operate to store and/or process video and/or audio produced by the video camera 134 and/or transmit the captured video and/or audio as a video and/or audio stream to the portable radio 104, other communication devices, and/or the infrastructure RAN 152 for further analysis. A microphone (not shown), or an array thereof, may be integrated in the video camera 134 and/or at the mobile communication device 133 (or additionally or alternatively made available at a separate location of the vehicle 132) and communicatively coupled to the mobile communication device 133 and/or vehicular transceiver 136 for capturing audio and storing, processing, and/or transmitting the audio in a same or similar manner to the video as set forth above.

The vehicle 132 may be a human-operable vehicle, or may be a self-driving vehicle operable under control of mobile communication device 133 perhaps in cooperation with video camera 134 (which may include a visible-light camera, an infrared camera, a time-of-flight depth camera, and/or a light detection and ranging (LiDAR) device). Command information and/or status information such as location and speed may be exchanged with the self-driving vehicle via the VAN and/or the PAN (when the PAN is in range of the VAN or via the VAN's infrastructure RAN link).

The vehicle 132 and/or transceiver 136, similar to the portable radio 104 and/or respective receivers, transmitters, or transceivers thereof, may include a location determination device integrated with or separately disposed in the mobile communication device 133 and/or transceiver 136 for determining (and storing and/or transmitting) a location of the vehicle 132.

In some embodiments, instead of a vehicle 132, a land, air, or water-based drone with the same or similar audio and/or video and communications capabilities and the same or similar self-navigating capabilities as set forth above may be disposed, and may similarly communicate with the user's 102 PAN and/or with the infrastructure RAN 152 to support the user 102 in the field.

The VAN may communicatively couple with the PAN disclosed above when the VAN and the PAN come within wireless transmission range of one another, perhaps after an authentication takes place there between. In some embodiments, one of the VAN and the PAN may provide infrastructure communications to the other, depending on the situation and the types of devices in the VAN and/or PAN and may provide interoperability and communication links between devices (such as video cameras) and sensors within the VAN and PAN.

Although the RSM 106, the laptop 114, and the vehicle 132 are illustrated in FIG. 1 as providing example video cameras and/or microphones for use in capturing audio and/or video streams, other types of cameras and/or microphones could be used as well, including but not limited to, fixed or pivotable video cameras secured to lamp posts, automated teller machine (ATM) video cameras, or other types of audio and/or video recording devices accessible via a wired or wireless network interface same or similar to that disclosed herein.

Infrastructure RAN 152 is a radio access network that provides for radio communication links to be arranged within the network between a plurality of user terminals. Such user terminals may be portable, mobile, or stationary and may include any one or more of the communication devices illustrated in FIG. 1, among other possibilities. At least one other terminal, e.g. used in conjunction with the communication devices, may be a fixed terminal, e.g. a base station, eNodeB, repeater, and/or access point. Such a RAN typically includes a system infrastructure that generally includes a network of various fixed terminals, which are in direct radio communication with the communication devices. Each of the fixed terminals operating in the RAN 152 may have one or more transceivers which may, for example, serve communication devices in a given region or area, known as a ‘cell’ or ‘site’, by radio frequency (RF) communication. The communication devices that are in direct communication with a particular fixed terminal are said to be served by the fixed terminal. In one example, all radio communications to and from each communication device within the RAN 152 are made via respective serving fixed terminals. Sites of neighboring fixed terminals may be offset from one another and may provide corresponding non-overlapping or partially or fully overlapping RF coverage areas.

Infrastructure RAN 152 may operate according to an industry standard wireless access technology such as, for example, an LTE, LTE-Advance, or 5G technology over which an OMA-PoC, a VoIP, an LTE Direct or LTE Device to Device, or a PoIP application may be implemented. Additionally or alternatively, infrastructure RAN 152 may implement a WLAN technology such as Wi-Fi perhaps operating in accordance with an IEEE 802.11 standard (e.g., 802.11a, 802.11b, 802.11g) or such as a WiMAX perhaps operating in accordance with an IEEE 802.16 standard.

Infrastructure RAN 152 may additionally or alternatively operate according to an industry standard LMR wireless access technology such as, for example, the P25 standard defined by the APCO, the TETRA standard defined by the ETSI, the dPMR standard also defined by the ETSI, or the DMR standard also defined by the ETSI. Because these systems generally provide lower throughput than the broadband systems, they are sometimes designated narrowband RANs.

Communications in accordance with any one or more of these protocols or standards, or other protocols or standards, may take place over physical channels in accordance with one or more of a TDMA (time division multiple access), FDMA (frequency divisional multiple access), OFDMA (orthogonal frequency division multiplexing access), or CDMA (code division multiple access) technique.

OMA-PoC, in particular and as one example of an infrastructure broadband wireless system, enables familiar PTT and “instant on” features of traditional half duplex communication devices, but uses communication devices operating over modern broadband telecommunications networks. Using PoC, wireless communication devices such as mobile telephones and notebook computers can function as PTT half-duplex communication devices for transmitting and receiving. Other types of PTT models and multimedia call models (MMCMs) are also available.

Floor control in an OMA-PoC session is generally maintained by a PTT server that controls communications between two or more wireless communication devices. When a user of one of the communication devices keys a PTT button, a request for permission to speak in the OMA-PoC session is transmitted from the user's communication device to the PTT server using, for example, a real-time transport protocol (RTP) message. If no other users are currently speaking in the PoC session, an acceptance message is transmitted back to the user's communication device and the user may then speak into a microphone of the communication device. Using standard compression/decompression (codec) techniques, the user's voice is digitized and transmitted using discrete auditory data packets (e.g., together which form an auditory data stream over time), such as according to RTP and internet protocols (IP), to the PTT server. The PTT server then transmits the auditory data packets to other users of the PoC session (e.g., to other communication devices in the group of communication devices or talkgroup to which the user is subscribed), using for example, one or more of a unicast, point to multipoint, or broadcast communication technique.

Infrastructure narrowband LMR wireless systems, on the other hand, operate in either a conventional or trunked configuration. In either configuration, a plurality of communication devices is partitioned into separate groups of communication devices. In a conventional system, each communication device in a group is selected to a particular radio channel (frequency or frequency & time slot) for communications associated with that communication device's group. Thus, each group is served by one channel, and multiple groups may share the same single frequency (in which case, in some embodiments, group IDs may be present in the group data to distinguish between groups using the same shared frequency).

In contrast, a trunked radio system and its communication devices use a pool of traffic channels for virtually an unlimited number of groups of communication devices (e.g., talkgroups). Thus, all groups are served by all channels. The trunked radio system works to take advantage of the probability that not all groups need a traffic channel for communication at the same time. When a member of a group requests a call on a control or rest channel on which all of the communication devices at a site idle awaiting new call notifications, in one embodiment, a call controller assigns a separate traffic channel for the requested group call, and all group members move from the assigned control or rest channel to the assigned traffic channel for the group call. In another embodiment, when a member of a group requests a call on a control or rest channel, the call controller may convert the control or rest channel on which the communication devices were idling to a traffic channel for the call, and instruct all communication devices that are not participating in the new call to move to a newly assigned control or rest channel selected from the pool of available channels. With a given number of channels, a much greater number of groups may be accommodated in a trunked radio system as compared with a conventional radio system.

Group calls may be made between wireless and/or wireline participants in accordance with either a narrowband or a broadband protocol or standard. Group members for group calls may be statically or dynamically defined. That is, in a first example, a user or administrator working on behalf of the user may indicate to the switching and/or radio network (perhaps at a call controller, PTT server, zone controller, or mobile management entity (MME), base station controller (BSC), mobile switching center (MSC), site controller, Push-to-Talk controller, or other network device) a list of participants of a group at the time of the call or in advance of the call. The group members (e.g., communication devices) could be provisioned in the network by the user or an agent, and then provided some form of group identity or identifier, for example. Then, at a future time, an originating user in a group may cause some signaling to be transmitted indicating that he or she wishes to establish a communication session (e.g., group call) with each of the pre-designated participants in the defined group. In another example, communication devices may dynamically affiliate with a group (and also disassociate with the group) perhaps based on user input, and the switching and/or radio network may track group membership and route new group calls according to the current group membership.

In some instances, broadband and narrowband systems may be interfaced via a middleware system that translates between a narrowband PTT standard protocol (such as P25) and a broadband PTT standard protocol (such as OMA-PoC). Such intermediate middleware may include a middleware server for performing the translations and may be disposed in the cloud, disposed in a dedicated on-premises location for a client wishing to use both technologies, or disposed at a public carrier supporting one or both technologies. For example, and with respect to FIG. 1, such a middleware server may be disposed in infrastructure RAN 152 at infrastructure controller 156 or at a separate cloud computing cluster such as cloud compute cluster 162 communicably coupled to controller 156 via internet protocol (IP) network 160, among other possibilities.

The infrastructure RAN 152 is illustrated in FIG. 1 as providing coverage for the portable radio 104, RSM video capture device 106, laptop 114, and vehicle transceiver 136 via a single fixed terminal 154 coupled to a single infrastructure controller 156 (e.g., a radio controller, call controller, PTT server, zone controller, MME, BSC, MSC, site controller, Push-to-Talk controller, or other network device) and including a dispatch console 158 operated by a dispatcher. In other embodiments, additional fixed terminals and additional controllers may be disposed to support a larger geographic footprint and/or a larger number of mobile devices.

The infrastructure controller 156 illustrated in FIG. 1, or some other back-end infrastructure device or combination of back-end infrastructure devices existing on-premises or in the remote cloud compute cluster 162 accessible via the IP network 160 (such as the Internet), may additionally or alternatively operate as a back-end electronic digital assistant, a back-end audio and/or video processing device, and/or a storage device consistent with the remainder of this disclosure.

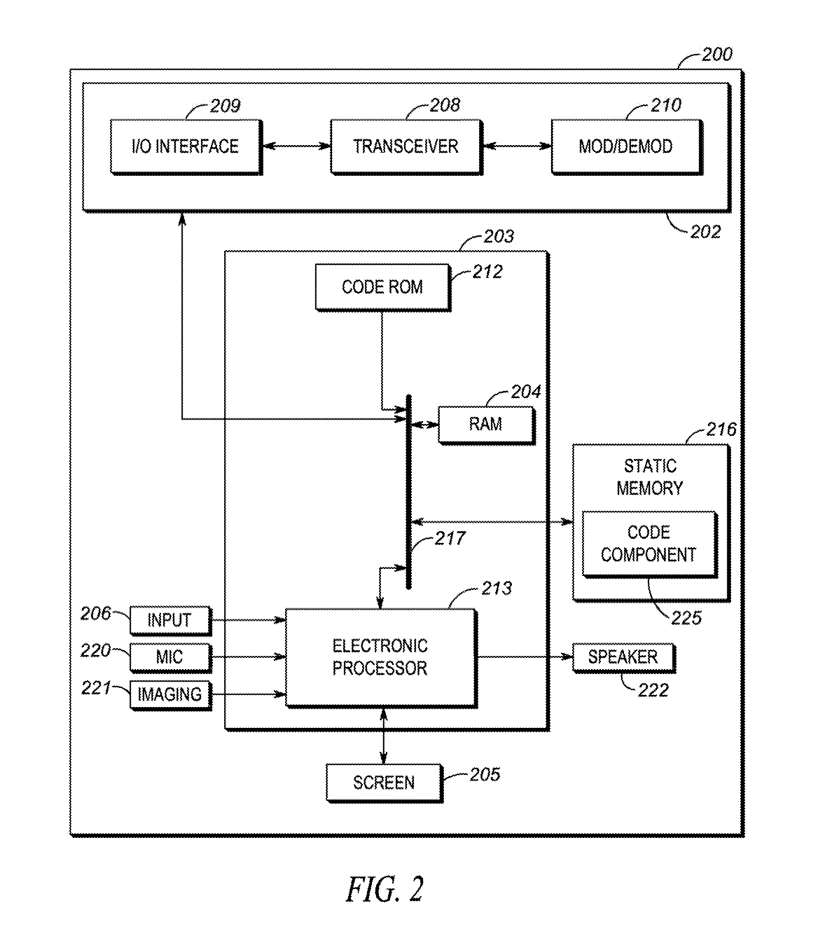

The IP network 160 may comprise one or more routers, switches, LANs, WLANs, WANs, access points, or other network infrastructure, including but not limited to, the public Internet. The cloud compute cluster 162 may be comprised of a plurality of computing devices, such as the one set forth in FIG. 2, one or more of which may be executing none, all, or a portion of an electronic digital assistant service, sequentially or in parallel, across the one or more computing devices. The one or more computing devices comprising the cloud compute cluster 162 may be geographically co-located or may be separated by inches, meters, or miles, and inter-connected via electronic and/or optical interconnects. Although not shown in FIG. 1, one or more proxy servers or load balancing servers may control which one or more computing devices perform any part or all of the electronic digital assistant service.

Database(s) 164 may be accessible via IP network 160 and/or cloud compute cluster 162, and may include databases such as a long-term video storage database, a historical or forecasted weather database, an offender database perhaps including facial recognition images to match against, a cartographic database of streets and elevations, a traffic database of historical or current traffic conditions, or other types of databases. Databases 164 may further include all or a portion of the databases described herein as being provided at infrastructure controller 156. In some embodiments, the databases 164 may be maintained by third parties (for example, the National Weather Service or a Department of Transportation, respectively). As shown in FIG. 1, the databases 164 are communicatively coupled with the infrastructure RAN 152 to allow the communication devices (for example, the portable radio 104, the RSM video capture device 106, the laptop 114, and the mobile communication device 133) to communicate with and retrieve data from the databases 164 via infrastructure controller 156 and IP network 160. In some embodiments, the databases 164 are commercial cloud-based storage devices. In some embodiments, the databases 164 are housed on suitable on-premises database servers. The databases 164 of FIG. 1 are merely examples. In some embodiments, the system 100 additionally or alternatively includes other databases that store different information. In some embodiments, the databases 164 and/or additional or other databases are integrated with, or internal to, the infrastructure controller 156.

Finally, although FIG. 1 describes a communication system 100 generally as a public safety communication system that includes a user 102 generally described as a police officer and a vehicle 132 generally described as a police cruiser, in other embodiments, the communication system 100 may additionally or alternatively be a retail communication system including a user 102 that may be an employee of a retailer and a vehicle 132 that may be a vehicle for use by the user 102 in furtherance of the employee's retail duties (e.g., a shuttle or self-balancing scooter). In other embodiments, the communication system 100 may additionally or alternatively be a warehouse communication system including a user 102 that may be an employee of a warehouse and a vehicle 132 that may be a vehicle for use by the user 102 in furtherance of the employee's retail duties (e.g., a forklift). In still further embodiments, the communication system 100 may additionally or alternatively be a private security communication system including a user 102 that may be an employee of a private security company and a vehicle 132 that may be a vehicle for use by the user 102 in furtherance of the private security employee's duties (e.g., a private security vehicle or motorcycle). In even further embodiments, the communication system 100 may additionally or alternatively be a medical communication system including a user 102 that may be a doctor or nurse of a hospital and a vehicle 132 that may be a vehicle for use by the user 102 in furtherance of the doctor or nurse's duties (e.g., a medical gurney or ambulance). In still another example embodiment, the communication system 100 may additionally or alternatively be a heavy machinery communication system including a user 102 that may be a miner, driller, or extractor at a mine, oil field, or precious metal or gem field and a vehicle 132 that may be a vehicle for use by the user 102 in furtherance of the miner, driller, or extractor's duties (e.g., an excavator, bulldozer, crane, front loader). As one other example, the communication system 100 may additionally or alternatively be a transportation logistics communication system including a user 102 that may be a bus driver or semi-truck driver at a school or transportation company and a vehicle 132 that may be a vehicle for use by the user 102 in furtherance of the driver's duties. Other possibilities exist as well.

b. Device Structure

FIG. 2 sets forth a schematic diagram that illustrates a communication device 200 according to some embodiments of the present disclosure. The communication device 200 may be, for example, embodied in the portable radio 104, the RSM video capture device 106, the laptop 114, the mobile communication device 133, the infrastructure controller 156, the dispatch console 158, one or more computing devices in the cloud compute cluster 162, or some other communication device not illustrated in FIG. 1, and/or may be a distributed communication device across two or more of the foregoing (or multiple of a same type of one of the foregoing) and linked via a wired and/or wireless communication link(s). In some embodiments, the communication device 200 (for example, the portable radio 104) may be communicatively coupled to other devices such as the sensor-enabled holster 118 as described above. In such embodiments, the combination of the portable radio 104 and the sensor-enabled holster 118 may be considered a single communication device 200.

While FIG. 2 represents the communication devices described above with respect to FIG. 1, depending on the type of the communication device, the communication device 200 may include fewer or additional components in configurations different from that illustrated in FIG. 2. For example, in some embodiments, communication device 200 acting as the infrastructure controller 156 may not include one or more of the screen 205, input device 206, microphone 220, imaging device 221, and speaker 222. As another example, in some embodiments, the communication device 200 acting as the portable radio 104 or the RSM video capture device 106 may further include a location determination device (for example, a global positioning system (GPS) receiver) as explained above. Other combinations are possible as well.

As shown in FIG. 2, communication device 200 includes a communications unit 202 coupled to a common data and address bus 217 of a processing unit 203. The communication device 200 may also include one or more input devices (e.g., keypad, pointing device, touch-sensitive surface, etc.) 206 and an electronic display screen 205 (which, in some embodiments, may be a touch screen and thus also act as an input device 206), each coupled to be in communication with the processing unit 203.

The microphone 220 may be present for capturing audio from a user and/or other environmental or background audio that is further processed by processing unit 203 in accordance with the remainder of this disclosure and/or is transmitted as voice or audio stream data, or as acoustical environment indications, by communications unit 202 to other portable radios and/or other communication devices. The imaging device 221 may provide video (still or moving images) of an area in a field of view of the communication device 200 for further processing by the processing unit 203 and/or for further transmission by the communications unit 202. A speaker 222 may be present for reproducing audio that is decoded from voice or audio streams of calls received via the communications unit 202 from other portable radios, from digital audio stored at the communication device 200, from other ad-hoc or direct mode devices, and/or from an infrastructure RAN device, or may playback alert tones or other types of pre-recorded audio.

The processing unit 203 may include a code Read Only Memory (ROM) 212 coupled to the common data and address bus 217 for storing data for initializing system components. The processing unit 203 may further include an electronic processor 213 (for example, a microprocessor or another electronic device) coupled, by the common data and address bus 217, to a Random Access Memory (RAM) 204 and a static memory 216.

The communications unit 202 may include one or more wired and/or wireless input/output (I/O) interfaces 209 that are configurable to communicate with other communication devices, such as the portable radio 104, the laptop 114, the wireless RAN 152, and/or the mobile communication device 133.

For example, the communications unit 202 may include one or more wireless transceivers 208, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), an LTE transceiver, a WiMAX transceiver perhaps operating in accordance with an IEEE 802.16 standard, and/or another similar type of wireless transceiver configurable to communicate via a wireless radio network.

The communications unit 202 may additionally or alternatively include one or more wireline transceivers 208, such as an Ethernet transceiver, a USB transceiver, or similar transceiver configurable to communicate via a twisted pair wire, a coaxial cable, a fiber-optic link, or a similar physical connection to a wireline network. The transceiver 208 is also coupled to a combined modulator/demodulator 210.

The electronic processor 213 has ports for coupling to the display screen 205, the input device 206, the microphone 220, the imaging device 221, and/or the speaker 222. Static memory 216 may store operating code 225 for the electronic processor 213 that, when executed, performs one or more of the steps set forth in FIGS. 3-5 and accompanying text.

In some embodiments, static memory 216 may also store, permanently or temporarily, an application mapping indicating, as a default or perhaps on a per user basis, which application(s) should be placed in a foreground of a mobile and/or portable associated with the user (or all users) when the user (or all users) are on-assignment, and which application(s) should be placed in a foreground of a mobile and/or portable associated with the user (or all users) when the user (or all users) are not-on-assignment. Static memory 216 may also store, permanently or temporarily, a current status (including one of an on-assignment status and a not-on-assignment status) for each of one or more users. Still further, static memory 216 may also store, permanently or temporarily, user speech indications (e.g., keywords or intents) associated with a first status change from a not-on-assignment related status of the user to an on—assignment related status of the user, and user speech indications associated with a second status change from an on-assignment related status of the user to a not-on-assignment related status of the user.

The static memory 216 may comprise, for example, a hard-disk drive (HDD), an optical disk drive such as a compact disk (CD) drive or digital versatile disk (DVD) drive, a solid state drive (SSD), a flash memory drive, or a tape drive, and the like.

### 2. PROCESSES FOR INFERRING, FROM A USER'S SPEECH TRANSMISSION TO ANOTHER USER, A CHANGE IN ASSIGNMENT STATUS AND CORRESPONDINGLY MODIFYING A USER INTERFACE OF AN ASSOCIATED MOBILE AND/OR PORTABLE COMPUTING DEVICE

In some embodiments, an individual component and/or a combination of individual components of the system 100 may be referred to as an electronic computing device that implements an electronic digital assistant as mentioned above. For example, the electronic computing device may be a single electronic processor (for example, the electronic processor 213 of the portable radio 104). In other embodiments, the electronic computing device includes multiple electronic processors distributed remotely from each other. For example, the electronic computing device may be implemented on a combination of at least two of the electronic processor 213 of the portable radio 104, the electronic processor 213 of the infrastructure controller 156, and the electronic processor 213 of a back-end device cloud compute cluster 162 accessible via the IP network 160.

To use the electronic digital assistant implemented by the electronic computing device, the user 102 may, for example, provide an oral query or statement that is received by the microphone 220 of the communication device 200 and transmitted to one or more other users (e.g., a dispatcher at dispatch console 158 or another user having a same or similar portable (hip) radio or having an associated mobile (vehicular) radio). The electronic computing device receives signals representative of the oral query or statement from the microphone 220 and analyzes the signals to determine the content of the oral query or statement. For example, the electronic computing device may include a natural language processing (NLP) engine configured to determine the intent and/or content of the oral query and/or statement. The electronic computing device may also be configured to determine a response to the oral query (for example, by retrieving stored data or by requesting data from a database such as one of the databases 164) and provide the response to an output device of the communication device 200 (for example, one or more of the speaker 222 via a generated audio response and the screen 205 via a generated text based response), and/or some other action to take in light of the contents of the oral query and/or statement. In other words, one or more of the communication device 200, embodied in one or more of the communication devices of FIG. 1, such as the portable radio 104, the infrastructure controller 156, and/or the cloud compute cluster 162, may include a NLP engine to analyze oral queries and/or statements received by the microphone 220 of the communication device 200 and provide responses to the oral queries and/or take other actions in light of the contents of the oral statements.

Although an oral query and/or statement is described above, in some embodiments, the electronic computing device receives and responds to other types of queries and inputs. For example, the user 102 may submit a text query to the electronic computing device by typing the text query into a hard keyboard input device 206 or a soft keyboard input provided on the screen 205 of the communication device 200. As another example, the user 102 may use the imaging device 221 to capture an image or video of an area and press a hard or soft key to send the image or video to the electronic computing device to, for example, allow the electronic computing device to identify an object in the image or video and provide a response and/or take other actions.

Turning now to FIG. 3, a flowchart diagram illustrates a process 300 for an electronic computing device operating as an electronic digital assistant to detect a user's natural language speech transmissions to one or more other users, and to infer from that speech, and without requiring further manual interaction such as touch-screen or keyboard interaction, a change in assignment status that can be correspondingly applied to automatically modify a user interface of a mobile and/or portable device computing device at their disposal. While a particular order of processing steps, message receptions, and/or message transmissions is indicated in FIG. 3 for exemplary purposes, timing and ordering of such steps, receptions, and transmissions may vary where appropriate without negating the purpose and advantages of the examples set forth in detail throughout the remainder of this disclosure.

Process 300 begins at step 302 where the electronic computing device monitors one of a private voice call and a talkgroup voice call associated with an in-field user. The voice call being monitored at step 302 may be a private voice call between a user having an associated portable radio, such as user 102 having associated portable radio 104 of FIG. 1, and another user having a similar associated portable radio, or with some other type of user having some other type of communications device, including but not limited to a dispatcher at dispatch console 158 of FIG. 1. The private voice call may be made using any one of the private call supporting applications or protocols (or combinations thereof) as already set forth above. Additionally or alternatively, the voice call being monitored at step 302 may be a talkgroup voice call between a user having an associated portable radio, such as user 102 having associated portable radio 104 of FIG. 1, and a plurality of other users having similar associated portable radios that are members of a same talkgroup, or with some other types of users having some other types of communications devices. The talkgroup voice call may be made using any one of the talkgroup call supporting applications or protocols (or combinations thereof) as already set forth above.

At step 304, the electronic computing device detects, in the one of the private and talkgroup voice call, first user speech from the in-field user. The electronic computing device may detect and match the first user speech as originating from the in-field user by, for example, detecting the first user speech via an integrated or communicatively coupled microphone at the electronic computing device. In one embodiment, for example, the portable radio 104 of FIG. 1 may detect first user speech originating from the user 102 via a microphone or array of microphones integrated into the portable radio (or the coupled RSM 106), all or a portion of which may be further transmitted in the private or talkgroup voice call of step 302, but which the electronic computing device may use to identify the first user speech as originating from the in-field user. In some embodiments, a corresponding identity of the in-field user may be stored at the electronic computing device, or may be retrieved from a device to user mapping stored in the infrastructure RAN 152 or elsewhere.

In still other embodiments, and where the electronic computing device executing step 304 may not be the same device as the device originally capturing the first user speech, some other mechanism may be used to identify the first user speech as being associated with the in-field user. For example, where the private or talkgroup voice call is being captured by portable radio 104 and then transmitted to infrastructure controller 156 and/or cloud compute cluster 162 for further processing, a voice print associated with the first user and previously sampled and stored may be compared directly to the first user speech, or parameters thereof compared to parameters of the first user speech, to identify the first user speech as associated with the in-field user. In still other embodiments, call signaling may be used to identify the source of the first user speech. For example, in half duplex LMR systems where a floor is requested and assigned to a single device (and associated user) at a time, an identity of the user (or device, which may then be mapped to a user using the device to user mapping noted above) may be determined based on a signal received from a floor controller computing device that determines which device (and thus user) has rights to transmit to the LMR talkgroup. Such floor ownership information may be stored, for example, at infrastructure controller 156 and accessed locally at step 304 by infrastructure controller 156, or may be provided by the infrastructure controller 156 to cloud compute cluster 162 for use at step 304. Other options are possible as well.

At step 306, the electronic computing device identifies a current status of the in-field user of one of an on-assignment related status and a not-on-assignment related status. The current status of the in-field user may be stored at the electronic computing device itself, may be stored in a user to status or device to status mapping stored at one of the electronic computing device, an infrastructure computing device such as infrastructure controller 156, or a cloud computing device such as cloud compute cluster 162, and made accessible to the electronic computing device, or some combination of the foregoing. The not-on-assignment related status may be any one of a status indicating that the in-field-user is not currently working on a particular assignment or incident or is working a general or default task or assignment as opposed to a particular assignment or task, or is working a relatively low-priority assignment or task relative to a higher priority assignment or task.

For example, a not-on-assignment related status for a police officer user may be associated with an in-field user that is working a general or default task like patrolling a neighborhood, is in the office or precinct doing paperwork or other such managerial or secretarial task, or is on a route returning to the office or precinct after completing a specific task such as working an incident such as a car crash or retail theft. In comparison, an on-assignment related status for a police officer user may be associated with an in-field user that is actively deployed (on duty) on a specific task or incident or event outside of the office or precinct (e.g., an incident such as a car crash or retail theft), or is on a route to a location of a specific task or incident outside of the office or precinct.

As another example, a not-on-assignment related status for a retail worker may be associated with an in-field user that is working a general or default task like walking aisles looking to assist customers, is in a manager's office or security office doing paperwork or other such managerial or secretarial tasks, is otherwise not currently engaged in a particular customer assistance, security, or hazardous spill task, or is on a route returning to the office after completing a specific task such as working a safety incident or engaging with an unhappy customer. In comparison, an on-assignment related status for a retail worker may be associated with an in-field user that is actively deployed on a specific task or incident outside of the office (e.g., an incident such as a reported safety hazard, customer assistance to a particular unhappy customer, a billing dispute with a particular customer, an emergency exit door opened event, or other specific deployable incidents, assignments, or events), or is on a route to a location of a specific task or incident outside of the office. Other types of users may have other types of on-assignment and not-on-assignment statuses as well.

Such various on-assignment and not-on-assignment status identifiers for a particular type of user may be stored at the electronic computing device, or may be stored elsewhere, including the an infrastructure computing device such as infrastructure controller 156, or a cloud computing device such as cloud compute cluster 162, and made accessible to the electronic computing device, or some combination of the foregoing.

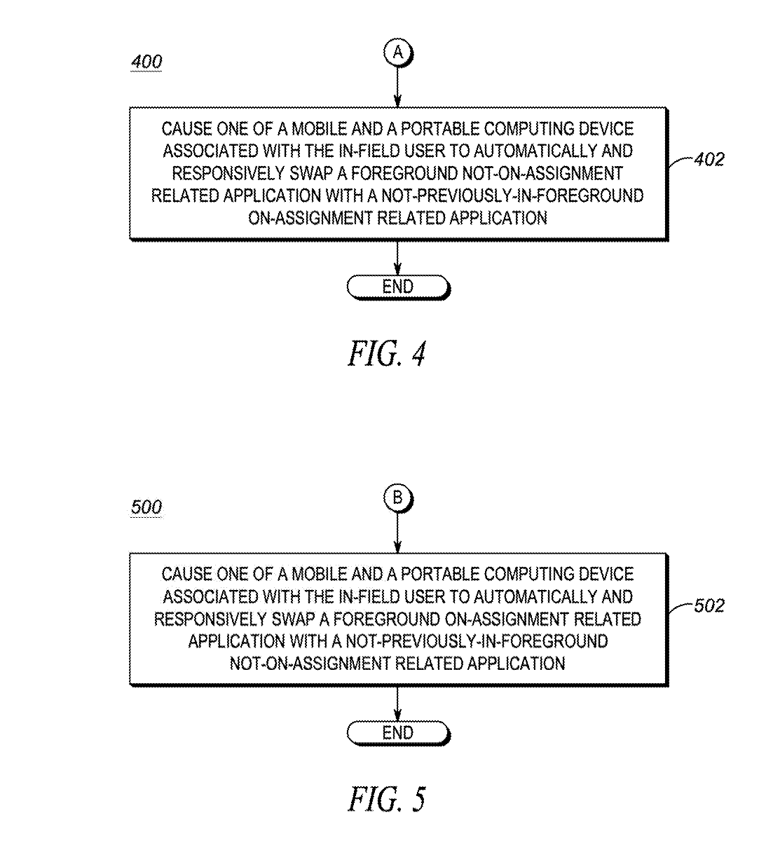

At step 308, the electronic computing device determines whether the first user speech is indicative of a first user status change of the in-field user in which the current status of the in-field user is the not-on-assignment related status and the first user speech is indicative of a change to the on-assignment related status. If the first user speech is not indicative of a first user status change of the in-field user in which the current status of the in-field user is the not-on-assignment related status and the first user speech is indicative of a change to the on-assignment related status, processing ends after step 308 for that branch of the flow chart. On the other hand, if the first user speech is indicative of a first user status change of the in-field user in which the current status of the in-field user is the not-on-assignment related status and the first user speech is indicative of a change to the on-assignment related status, processing proceeds to step 402 of FIG. 4.

The electronic computing device may determine whether the first user speech is indicative of a first user status change of the in-field user in which the current status of the in-field user is the not-on-assignment related status and the first user speech is indicative of a change to the on-assignment related status in a number of ways. For example, the electronic computing device may apply an NLP algorithm to the first user speech in order to determine an intent of the speech and, as a function of a determined current status of the in-field user, may make a determination of an intent of the in-field user to change from a not-on-assignment related status to an on-assignment related status.

In other embodiments, the electronic computing device may text-convert the first user speech to text, and reference a mapping of user speech indications (e.g., keywords) determined to be indicative of an intent of the in-field user to change from a not-on-assignment related status to an on-assignment related status based on a threshold minimum number of one or more matching keywords.

For example, a police officer user may have a current not-on-assignment status of “patrol,” during which time the electronic computing device may detect the in-field user providing first user speech in a private (e.g., to a dispatcher or commander) or group voice call (e.g., to a talkgroup for the department or precinct to which the police officer belongs or a talkgroup for incidents in general or the particular incident to which he or she is about to respond) that is indicative of an intent of the police officer to respond to an active incident, such as “Officer Perkins responding to the domestic disturbance at 123 Elm St.” The electronic computing device may then infer, via an NLP algorithm, or may detect via matching of keyword “responding” and a keyword type of incident and/or keyword address, that the in-field user is transitioning from a not-on-assignment status of “patrol” to an on-assignment status of “responding to incident” or “responding to domestic disturbance.”

As another example, a retail worker user may have a current not-on-assignment status of “walking aisles,” during which time the electronic computing device may detect the in-field user providing first user speech in a private (e.g., to a manager or shift supervisor) or group voice call (e.g., to all other retail workers at that location) that is indicative of an intent of the retail worker to respond to an active incident or event, such as “This is Joe, I'll handle the request for customer assistance in Aisle 3.” The electronic computing device may then infer, via an NLP algorithm, or may detect via matching of keyword “handle” and a keyword “request”, “customer”, and/or “assistance”, that the in-field user is transitioning from a not-on-assignment status of “walking aisles” to an on-assignment status of “customer assistance” or “responding to request for assistance.”

At step 402 of process 400 in FIG. 4, the electronic computing device then causes one of a mobile and a portable computing device associated with the in-field user (such as a mobile or portable radio) to automatically and responsively swap a foreground not-on-assignment related application with a not-previously-in-foreground on-assignment related application. The electronic computing device causing the swapping may include the electronic computing device (acting as the mobile and/or portable computing device itself) to swap a foreground not-on-assignment related application with a not-previously-in-foreground on-assignment related application. In other embodiments, the electronic computing device causing the swapping may include the electronic computing device (acting as the infrastructure controller 156 and/or cloud compute cluster 162) identifying the mobile and/or portable computing device associated with the in-field user (as previously identified above or newly identified via a same or similar in-field user to mobile computing device or in-field user to portable computing device mapping accessible locally or remotely to the electronic computing device) and transmitting a message informing the target mobile and/or portable computing device of the status change and/or instructing the target mobile and/or portable computing device to swap a foreground not-on-assignment related application with a not-previously-in-foreground on-assignment related application. In some embodiments, the message may additionally identify one or more particular not-on-assignment related applications with which to swap with one or more corresponding not-previously-in-foreground on-assignment related applications. In other embodiments, the message may not particularly identify any on-assignment or not-on-assignment related applications, but may rely upon a configuration of the target mobile and/or portable computing device to identify such on-assignment and not-on-assignment related applications with which to swap.

For example, where the in-field user at step 402 is a police officer and the on-assignment status an in-incident status and the not-on-assignment status a not-in-incident status, the electronic computing device may cause a portable and/or mobile computing device associated with the police officer transitioning from a not-on-assignment status of “on patrol” to an on-assignment status of “responding to incident” to swap a foreground application associated with the “on patrol” status (e.g., such as a mapping application providing a patrol route for the police officer to follow, a PTT application for speaking to a talkgroup associated with all other police officers in a same organization as the police officer, a task list setting forth one or more tasks related or unrelated to the patrol route that the police officer may choose to perform or accept, an incident list setting forth one or more current or past incidents associated with the police officer or the organization to which the police officer belongs, a status indicator application setting forth a status of the police officer and/or the other police officers in the same organization to which the police officer belongs, a contact list setting forth identities of one or more other police officers or other employees of the same organization to which the police officer belongs, a general note taking application in which the police officer may record notes relative to the patrol route, and/or other not-on-assignment related applications) and replace it with a not-previously-in-foreground different application (or different type of application) associated with the “responding to incident” status (e.g., such as a mapping application providing an incident route for the police officer to follow to arrive at the incident, a PTT application for speaking to a talkgroup associated with all other police officers (and/or other persons) associated with the incident, a task list setting forth one or more tasks relating to the incident, an incident timeline setting forth events (and perhaps indicating summary, type, importance, who entered the event, etc.) associated with the incident, a status indicator application setting forth a status of the police officer and/or the other police officers or other persons associated with the incident, a contact list setting forth identities of one or more other police officers or other employees or persons associated with the incident, an incident-specific note taking application in which the police officer may record notes relative to the incident, and/or other on-assignment related applications).

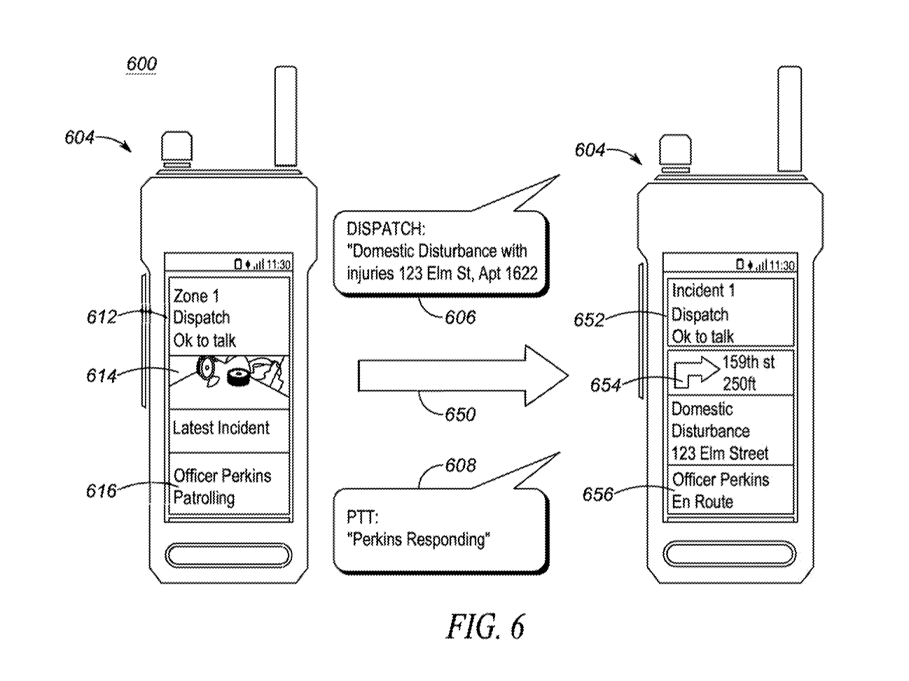

FIG. 6 sets forth an example portable radio 604 transition 600 commensurate with the foregoing. In this example, the in-field user police officer associated with the example portable radio 604 is currently in a not-on-assignment (i.e., not-in-incident “on patrol”) status, and the portable radio 604 displays a first “on patrol” related application in the foreground as a Zonel Dispatch PTT application 612 that allows the police officer to key up a talkgroup and speak to a dispatcher associated with the Zonel patrol beat and/or all other officers and/or employees associated with the Zonel patrol beat. The portable radio 604 additionally displays a second “on patrol” related application in the foreground as a list of current incidents application 614 that lists one or more current incidents associated with the Zonel patrol beat or perhaps associated with the officer's organization as a whole (and in some embodiments including a current status and/or distance from the police officer). Finally, the portable radio 604 also displays a third “on patrol” related application in the foreground as an officer status application 616 that lists a current status of the police officer associated with the example portable radio 604 (and, in some embodiments, statuses of other officers associated with the Zonel patrol beat or other officers associated with the same organization as the police officer).

While the police officer and his or her associated example portable radio 604 remains in the “on patrol” status state, the portable radio 604 receives a voice call (private call or talkgroup call) from a dispatcher and plays back speech indicating that a “Domestic Distance with Injuries” has occurred at “123 Elm St.” as indicated in voice text bubble 606. In response, the police officer associated with the portable radio 604 keys up and indicates “Perkins Responding” as indicated in voice text bubble 608, which is then transmitted by the portable radio 604 to the dispatcher, perhaps via a same or different private or talkgroup voice call as that over which the voice text bubble 606 contents were received. As a result of the electronic digital assistant processing the first user speech contents indicated in voice text bubble 608, perhaps at same or similar steps as steps to steps 302-306 above, the electronic digital assistant causes the portable radio 604 to transition 650 and swap at least one of the “on patrol” related foreground applications 612-616 with a different (or different type of) on-assignment (i.e., in-incident in this case) application that was not previously in the foreground. As shown in FIG. 6, while a state of the Zonel Dispatch PTT application 612 changed as shown in Zonel Dispatch PTT application 652, the same (or same type of) application remained in the foreground, and while a state of the officer status application 616 changed as shown in officer status application 656, the same (or same type of) application remained in the foreground, and thus for at least these two applications, the foreground not-on-assignment applications were not swapped with a different (or different type of) not-previously-in-foreground on-assignment related application.

However, the “on patrol” related list of current incidents application 614 that listed one or more current incidents associated with the Zonel patrol beat or perhaps associated with the officer's organization as a whole was replaced (i.e., swapped) with another not-previously-in-foreground on-assignment (e.g., in-incident in this case) related incident route mapping application 654 providing the officer a route to the domestic disturbance incident with which the officer had decided to respond, responsive to the inferred intent of the officer extracted from his voice speech provided on the private or talkgroup voice channel to the dispatcher. As a result, the officer can immediately proceed to respond to the indicated domestic disturbance incident without having to manually interface with the example portable radio 604 and draw his or her attention away from responding to the incident quickly and efficiently. Although only one application is illustrated as being swapped out in FIG. 6, in other embodiments, more than one or all three of the applications could be swapped out. Furthermore, a state of the swapped-in application not previously in the foreground may be updated as a function of the one or more applications that were previously in the foreground (whether or not swapped out). For example, a current location used for the swapped-in incident route mapping application 654 to plan the route to the incident may be drawn from a location previously manually or automatically entered into a prior foreground note-taking application that may or may not have been swapped out prior to swapping in the incident route mapping application 654. Other possibilities exist as well.

Although the example above uses public safety related applications as examples, in other embodiments, on-assignment and not-on-assignment related applications could similarly be applied for other types of users. For example, for a retail user, not-on-assignment related applications may include a mapping application providing a route for a retail worker to follow indoors to ensure that his or her department is covered and visible to customers, a PTT application for speaking to a talkgroup associated with all other employees of a same department or store as the retail user, a task list setting forth one or more tasks that the retail user may choose to perform or accept, an incident list setting forth one or more current or past security, customer, or hazardous spill incidents associated with the retail user or the organization to which the retail user belongs, a status indicator application setting forth a status of the retail user and/or the other retail users in the same organization (e.g., availability, location, seniority, title, assigned department, assigned task, etc.), a contact list setting forth identities of one or more other retail users or other employees of the same organization to which the retail user belongs, a general note taking application in which the retail user may record notes relative to the indoor department route, and/or other not-on-assignment related applications), and on-assignment related applications may include an indoor mapping application providing a route for the retail user to follow to arrive at a location at which a customer has requested assistance, a PTT application for speaking to a talkgroup associated with a particularly assigned task associated with a retail incident (e.g., security staff for an assigned security task, web service staff for an assigned online order task, etc.), a task list setting forth one or more sub-tasks associated with a particularly assigned task (e.g., customer service request may include a task of meeting with the customer requesting assistance and a task of documenting the request and the assistance provided), a status indicator application setting forth a status of the retail user and/or the other retail users or other persons associated with a same assigned retail task, a contact list setting forth identities of one or more other retail users or other employees or persons associated with a same assigned retail task, a task-specific note taking application in which the retail user may record notes relative to the assigned task, and/or other on-assignment related applications.

Other types of users, such as security, transportation, or health care users, could have other associated on-assignment and not-on-assignment related applications.

Returning now to FIG. 3, at step 310, the electronic computing device determines whether the first user speech is indicative of a second user status change of the in-field user in which the current status of the in-field user is the on-assignment related status and the first user speech is indicative of a change to the not-on-assignment related status. If the first user speech is not indicative of a second user status change of the in-field user in which the current status of the in-field user is the on-assignment related status and the first user speech is indicative of a change to the not-on-assignment related status, processing ends after step 310 for that branch in the flowchart. On the other hand, if the first user speech is indicative of a second user status change of the in-field user in which the current status of the in-field user is the on-assignment related status and the first user speech is indicative of a change to the not-on-assignment related status, processing proceeds to step 502 of FIG. 5.

The electronic computing device may determine whether the first user speech is indicative of a second user status change of the in-field user in which the current status of the in-field user is the on-assignment related status and the first user speech is indicative of a change to the not-on-assignment related status in a same or similar number of ways as already set forth above with respect to the first user status change.

For example, a police officer user may have a current on-assignment status of “responding to domestic disturbance,” during which time the electronic computing device may detect the in-field user providing first user speech in a private or group voice call that is indicative of an intent of the police officer to convey that the active incident has completed, such as “Suspect in custody” or “heading back to HQ.” The electronic computing device may then infer, via an NLP algorithm, or may detect via matching of keyword “suspect” and “custody” (or “heading back” and “HQ”) that the in-field user is transitioning from an on-assignment status of “responding to domestic disturbance” to a not-on-assignment status of “patrol” or “returning to headquarters.”

As another example, a retail worker user may have a current on-assignment status of “responding to request for assistance,” during which time the electronic computing device may detect the in-field user providing first user speech in a private or group voice call that is indicative of an intent of the retail worker to end the specific incident or event, such as “Heading back to the office” or “Handled that request.” The electronic computing device may then infer, via an NLP algorithm, or may detect via matching of keyword “heading back” and “office” (or “handled” and “request”), that the in-field user is transitioning from an on-assignment status of “responding to request for assistance” to a not-on-assignment status of “walking aisles” or “in the office.”

At step 502 of process 500 in FIG. 5, the electronic computing device causes one of a mobile and a portable computing device (such as a mobile or portable radio) associated with the in-field user to automatically and responsively swap a foreground on-assignment related application with a not-previously-in-foreground not-on-assignment related application. The electronic computing device causing the swapping may include the electronic computing device (acting as the mobile and/or portable computing device itself) to swap a foreground on-assignment related application with a not-previously-in-foreground not-on-assignment related application. In other embodiments, the electronic computing device causing the swapping may include the electronic computing device (acting as the infrastructure controller 156 and/or cloud compute cluster 162) identifying the mobile and/or portable computing device associated with the in-field user (as previously identified above or newly identified via a same or similar in-field user to mobile computing device or in-field user to portable computing device mapping accessible locally or remotely to the electronic computing device) and transmitting a message informing the target mobile and/or portable computing device of the status change and/or instructing the target mobile and/or portable computing device to swap a foreground on-assignment related application with a not-previously-in-foreground not-on-assignment related application. In some embodiments, the message may additionally identify one or more particular on-assignment related applications with which to swap with one or more corresponding not-previously-in-foreground not-on-assignment related applications. In other embodiments, the message may not particularly identify any on-assignment or not-on-assignment related applications, but may rely upon a configuration of the target mobile and/or parable computing device to identify such on-assignment and not-on-assignment related applications with which to swap.

For example, where the in-field user at step 502 is a police officer and the on-assignment status an in-incident status and the not-on-assignment status a not-in-incident status, the electronic computing device may cause a portable and/or mobile computing device associated with a police officer to transition from an on-assignment status of “responding to incident” to a not-on-assignment status of “on patrol” or “returning to station” to swap a foreground application associated with the “responding to incident” status (e.g., such as a mapping application providing an incident route for the police officer to follow to arrive at the incident, a PTT application for speaking to a talkgroup associated with all other police officers (and/or other persons) associated with the incident, a task list setting forth one or more tasks relating to the incident, an incident timeline setting forth events (and perhaps indicating summary, type, importance, who entered the event, etc.) associated with the incident, a status indicator application setting forth a status of the police officer and/or the other police officers or other persons associated with the incident, a contact list setting forth identities of one or more other police officers or other employees or persons associated with the incident, an incident-specific note taking application in which the police officer may record notes relative to the incident, and/or other on-assignment related applications) and replace it with a not-previously-in-foreground different application associated with the “on patrol” or “returning to station” status (e.g., such as a mapping application providing a patrol route for the police officer to follow or providing a route back to the station/headquarters, a PTT application for speaking to a talkgroup associated with all other police officers in a same organization as the police officer, a task list setting forth one or more tasks related or unrelated to the patrol route that the police officer may choose to perform or accept, an incident list setting forth one or more current or past incidents associated with the police officer or the organization to which the police officer belongs, a status indicator application setting forth a status of the police officer and/or the other police officers in the same organization, a contact list setting forth identities of one or more other police officers or other employees of the same organization to which the police officer belongs, a general note taking application in which the police officer may record notes relative to the patrol route, and/or other not-on-assignment related applications).

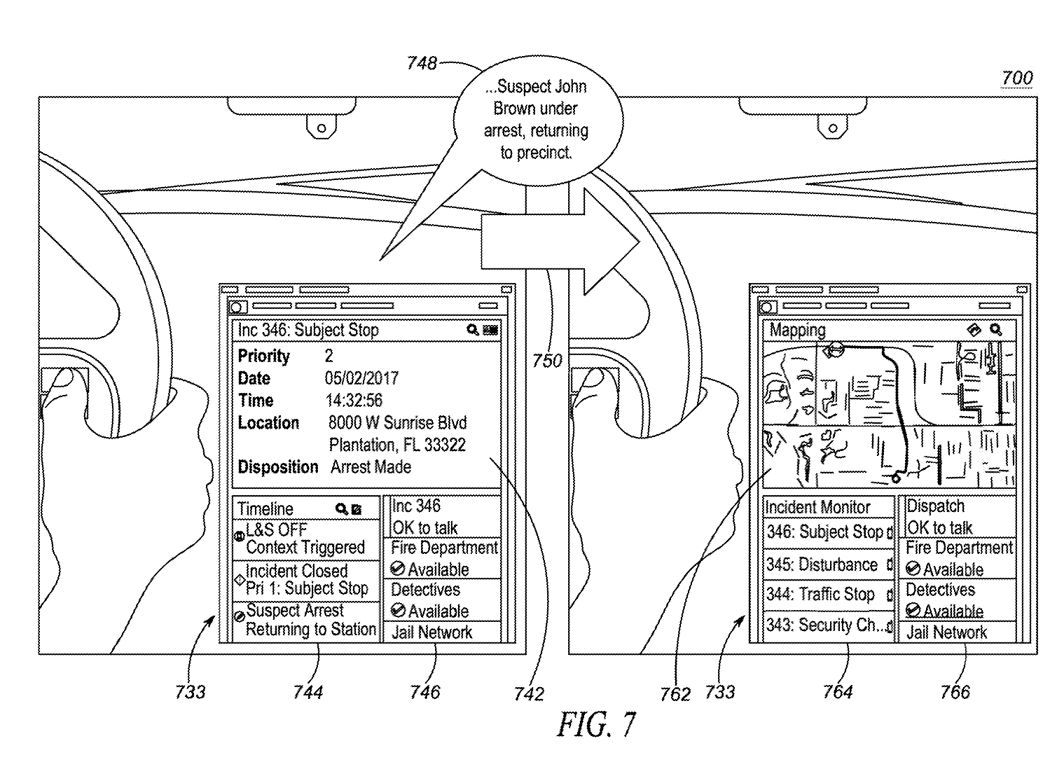

FIG. 7 sets forth an example mobile radio 733 transition 700 commensurate with the foregoing. In this example, the in-field user police officer associated with the example mobile radio 733 is currently in an on-assignment (i.e., in-incident) status, and the mobile radio 733 displays a first “in incident” related application in the foreground as an in-incident status application 742 that allows the police officer to track an on-going status of a currently assigned incident. The mobile radio 733 additionally displays a second “in incident” related application in the foreground as an incident timeline application 744 that gives a time-wise tracking of events associated with the currently assigned incident. Finally, the mobile radio 733 also displays a third “in incident” related application in the foreground as an in-incident PTT application 746 for speaking to a talkgroup associated with all other police officers and/or other users associated with the current incident.

While the police officer and his or her associated example mobile radio 733 remains in the “in incident” status state, the police officer uses mobile radio 733 to make a voice call (private call or talkgroup call) to a dispatcher or some other user or group of users, and states that “suspect John Brown under arrest, returning to precinct” as indicated in voice text bubble 748 including the illustrated second user speech. As a result of the electronic digital assistant processing the second user speech contents indicated in voice text bubble 748, perhaps at same or similar steps as steps to steps 302-306 above, the electronic digital assistant causes the mobile radio 733 to transition 750 and swap at least one of the “in incident” related foreground applications 742-746 with a different (or different type of) not-on-assignment (i.e., not-in-incident in this case) application that was not previously in the foreground. As shown in FIG. 7, while a state of the PTT application 746 changed as shown in the not-in-incident PTT application 766, the same (or same type of) application remained in the foreground.

However, the in-incident status application 742 that allowed the police officer to track an on-going status of a current incident was replaced (i.e., swapped) with another not-previously-in-foreground not-on-assignment (e.g., not-in-incident in this case) related return route mapping application 762 providing the office a route back to the station/headquarters.

Furthermore, the in-incident timeline application 744 that gives a time-wise tracking of events associated with the current incident was replaced (i.e., swapped) with another not-previously-in-foreground not-on-assignment (e.g., not-in-incident in this case) related list of current incidents application 764 that lists one or more current incidents associated with the police officer or perhaps associated with the police officer's organization as a whole (and in some embodiments including a current status and/or distance from the police officer).

As a result, the police officer can immediately proceed back to the station/headquarters and/or determine which next incident to aid or respond to without having to manually interface with the example mobile radio 733 and draw his or her attention away from driving the vehicle and/or responding to the next incident quickly and efficiently. Although two applications are illustrated as being swapped out in FIG. 7, in other embodiments, less than or more than two of the applications could be swapped out. Furthermore, a state of the swapped-in application not previously in the foreground may be updated as a function of the one or more applications that were previously in the foreground (whether or not swapped out). For example, whether the mapping application 762 has a state indicating a route back to the police station/headquarters or whether the mapping application 762 has a state indicating a route to a next incident (or a patrol route) may be drawn from a context or state of another prior foreground (but now swapped out) application such as the in-incident status application 742 which may provide information to the mapping application 762 swapped in whether the police officer has a an arrested suspect, victim, or witness to bring to the station/headquarters, or whether the prior incident is entirely complete and the office can return to a patrol route. Same or similar information could be drawn from the incident timeline application 744 and inform the mapping application 762 or other not-on-assignment foreground applications newly swapped in to the display of the mobile radio 733. Other possibilities exist as well.

In some embodiments, instead of automatically and responsively swapping the applications as set forth in steps 402 and 502 of FIGS. 4 and 5, a first time that the first or second user status change is detected, the user may be prompted to confirm the swapping of the applications (e.g., a notice may be displayed requesting confirmation before the swap is made, or a time indicated in which, if no other action is taken by the user to stop it, the applications indicated will be swapped due to the detected user status change). Subsequent times in which the same type of user status change is detected (and the user confirmed the swap previously), the swapping may be performed automatically and responsively as indicated in steps 402 and 502.

Furthermore, although FIG. 6 focused on a transition relative to a portable radio 604 and FIG. 7 focused on a transition relative to a mobile radio 733, the examples set forth above relative to the portable radio 604 are equally applicable to the mobile radio 733 and vice versa. Furthermore, and in some embodiments, steps 402 or 502 may cause same, similar, or different swaps of foreground applications between on-assignment and not-on-assignment applications at both of the mobile radio 733 and the portable radio 604 associated with a same in-field user from which first user speech is determined to be indicative of a first or second user status change at one of steps 308 or 310. In the case where the electronic digital assistant executing steps 402 or 502 is one of the portable and the mobile radio, the electronic digital assistant may transmit a message to the other of the portable and the mobile radio (perhaps as stored at the electronic digital assistant or perhaps identified after requesting, from an infrastructure device such as infrastructure controller 156 or cloud computer cluster 162, an identity of any other radios associated with the user) to make the corresponding swap in accordance with the description already set forth above. In the case where the electronic digital assistant executing steps 402 or 502 is one of the infrastructure controller 156 or the cloud computer cluster 162, the electronic digital assistant may access a user to radio mapping stored at the infrastructure controller 156, the cloud computer cluster 162, or the databases 164 and identify all radios associated with the officer, and transmit a message to each radio to make the corresponding swap in accordance with the description already set forth above.

Still further, the not-previously-in-foreground application in either of steps 402 or 502 may be an application that is stored but was not previously running at the portable and/or mobile computing device and is newly executed to replay the application being swapped out of the foreground, or may be an application that was already previously running as a background process (including possibly receiving application state or data updates as a background process) at the portable and/or mobile computing device, and is swapped into the foreground as a result of step 402 or 502.

### 3. CONCLUSION

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (for example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method at an electronic digital assistant computing device for natural language detection of a user status change and corresponding modification of a user interface, the method comprising:
monitoring, at an electronic computing device, one of a private voice call and a talkgroup voice call associated with an in-field user;
detecting, by the electronic computing device over the one of the private voice call and the talkgroup voice call associated with the in-field user, first user speech from the in-field user;
identifying, by the electronic computing device, a current status of the in-field user of one of an on-assignment related status and a not-on-assignment related status;
determining, by the electronic computing device, that the first user speech is indicative of one of (i) a first status change of the in-field user in which the current status of the in-field user is the not-on-assignment related status and the first user speech is indicative of a change to the on-assignment related status and (ii) a second status change of the in-field user in which the current status of the in-field user is the on-assignment related status and the first user speech is indicative of a change to the not-on-assignment related status; and
when the determining, by the electronic computing device, is that the first user speech is indicative of the first status change, responsively:
causing, by the electronic computing device, one of a mobile and a portable computing device associated with the in-field user to automatically and responsively swap a foreground not-on-assignment related application with a not-previously-in-foreground on-assignment related application; and
when the determining, by the electronic computing device, is that the first user speech is indicative of the second status change, responsively:
causing, by the electronic computing device, one of the mobile and the portable computing device associated with the in-field user to automatically and responsively swap a foreground on-assignment related application with a not-previously-in-foreground not-on-assignment related application.

2. The method of claim 1, wherein the electronic computing device is an infrastructure computing device, and:
when the determining, by the electronic computing device, is that the first user speech is indicative of the first status change, causing the one of the mobile and the portable computing device associated with the in-field user to automatically and responsively swap a foreground not-on-assignment related application with a not-previously-in-foreground on-assignment related application comprises identifying the one of the mobile and the portable computing device associated with the in-field user via an in-field-user to mobile or portable computing device mapping and transmitting, to the identified one of the mobile and the portable computing device associated with the in-field user, an instruction to swap the foreground not-on-assignment related application with the not-previously-in-foreground on-assignment related application; and
when the determining, by the electronic computing device, is that the first user speech is indicative of the second status change, causing the one of the mobile and the portable computing device associated with the in-field user to automatically and responsively swap a foreground on-assignment related application with a not-previously-in-foreground not-on-assignment related application comprises identifying the one of the mobile and the portable computing device associated with the in-field user via an in-field-user to mobile or portable computing device mapping and transmitting, to the identified one of the mobile and the portable computing device associated with the in-field user, an instruction to swap the foreground on-assignment related application with the not-previously-in-foreground not-on-assignment related application.

3. The method of claim 1, wherein the electronic computing device is the one of the mobile and the portable computing device associated with the in-field user, and:
when the determining, by the electronic computing device, is that the first user speech is indicative of the first status change, the electronic computing device responsively swapping a foreground not-on-assignment related application with a not-previously-in-foreground on-assignment related application; and
when the determining, by the electronic computing device, is that the first user speech is indicative of the second status change, the electronic computing device responsively swapping a foreground on-assignment related application with a not-previously-in-foreground not-on-assignment related application.

4. The method of claim 1, wherein:
the on-assignment related status is an in-incident related status relative to a public safety incident that the in-field user is responding to, the not-on-assignment related status is a not-in-incident related status in which there is no current public safety incident to which the in-field user is responding to, the on-assignment related application is an in-incident related application, and the not-on-assignment related application is a not-in-incident related application; and
the determining, by the electronic computing device, is that the first user speech is indicative of the first status change; and
the method further comprising swapping the foreground not-in-incident related application comprising one of a patrol route mapping application, a departmental contact list application, an incident monitor list application listing all active and/or recent incidents associated with a department to which the in-field user belongs, a not-in-incident task list application identifying non-incident related tasks for the in-field user to complete, and a non-in-incident related talkgroup status indicator application with a not-previously-in-foreground in-incident-related application comprising one of an in-incident location mapping application indicating locations of other users assigned to a same incident, an in-incident contact list application indicating callable other users assigned to a same incident, an in-incident task list application identifying incident related tasks for the in-field user or other users assigned to the incident to complete, and an in-incident related talkgroup status indicator application.

5. The method of claim 4, wherein the foreground not-in-incident related application is swapped with a different type of not-previously-in-foreground in-incident-related application.

6. The method of claim 5, wherein the foreground not-in-incident related application is the incident monitor list application and the not-previously-in-foreground in-incident-related application is one of the in-incident location mapping application, the in-incident contact list application, the in-incident task list application, and the in-incident related talkgroup status indicator application.

7. The method of claim 1, wherein the determining, by the electronic computing device, is that the first user speech is indicative of the second status change;
the method further comprising swapping an in-foreground on-assignment related application comprising one of an on-assignment location mapping application indicating locations of other users assigned to a same assignment, an on-assignment contact list application indicating callable other users assigned to a same assignment, an on-assignment task list application identifying assignment related tasks for the in-field user or other users assigned to the assignment to complete, and an on-assignment related talkgroup status indicator application with a not-previously-in-foreground not-on-assignment related application comprising one of a patrol route mapping application, a departmental contact list application, an assignment monitor list application listing all active and/or recent assignments associated with a department to which the in-field user belongs, a not-on-assignment task list application identifying non-assignment related tasks for the in-field user to complete, and a non-assignment related talkgroup status indicator application.

8. The method of claim 7, wherein the in-foreground on-assignment related application is swapped with a different type of not-previously-in-foreground not-on-assignment related application.

9. The method of claim 7, wherein the in-foreground on-assignment related application is one of the on-assignment location mapping application, the on-assignment contact list application, the on-assignment task list application, and the on-assignment related talkgroup status indicator application and the not-previously-in-foreground not-on-assignment related application is the assignment monitor list application.

10. The method of claim 1, wherein the one of the mobile and the portable computing device associated with the in-field user is the portable computing device worn on a body of the in-field user.

11. The method of claim 1, wherein the one of the mobile and the portable computing device associated with the in-field user is the mobile computing device coupled to a vehicle associated with the in-field user.

12. The method of claim 1, wherein:
when the determining, by the electronic computing device, is that the first user speech is indicative of the first status change:
causing, by the electronic computing device, both of the mobile and the portable computing device associated with the in-field user to automatically and responsively swap a foreground not-on-assignment related application with a not-previously-in-foreground on-assignment related application; and
when the determining, by the electronic computing device, is that the first user speech is indicative of the second status change:
causing, by the electronic computing device, both of the mobile and the portable computing device associated with the in-field user to automatically and responsively swap a foreground on-assignment related application with a not-previously-in-foreground not-on-assignment related application.

13. The method of claim 12, wherein:
when the determining, by the electronic computing device, is that the first user speech is indicative of the first status change:
one of the foreground not-on-assignment related application and the not-previously-in-foreground on-assignment related application swapped by the mobile computing device is different than one of the foreground not-on-assignment related application and the not-previously-in-foreground on-assignment related application swapped by the portable computing device; and
when the determining, by the electronic computing device, is that the first user speech is indicative of the second status change:
one of the foreground on-assignment related application and the not-previously-in-foreground not-on-assignment related application swapped by the mobile computing device is different than one of the foreground on-assignment related application and the not-previously-in-foreground not-on-assignment related application swapped by the portable computing device.

14. The method of claim 1, further wherein:
when the determining, by the electronic computing device, is that the first user speech is indicative of the first status change, responsively:
causing, by the electronic computing device, a state of the swapped in not-previously-in-foreground on-assignment related application to be modified based on information obtained from one of a plurality of foreground not-on-assignment related applications existing in a foreground prior to the first status change; and
when the determining, by the electronic computing device, is that the first user speech is indicative of the second status change, responsively:
causing, by the electronic computing device, a state of the swapped in not-previously-in-foreground not-on-assignment related application to be modified based on information obtained from one of a plurality of foreground on-assignment related applications existing in a foreground prior to the second status change.

15. The method of claim 1, further comprising transmitting, by the electronic computing device to an infrastructure computer aided dispatch (CAD) computing device, a message indicating one of the first and the second status change.

16. The method of claim 1, further comprising recording, by the electronic computing device in an assignment timeline application associated with an assignment, one of the first and the second status change associated with the in-field user.

17. The method of claim 1, further wherein:
when the determining, by the electronic computing device, is that the first user speech is indicative of the first status change, responsively:
a first time in which the first status change is detected, prompting the in-field user to confirm that the foreground not-on-assignment related application will be swapped with the not-previously-in-foreground on-assignment related application; and
receiving confirmation from the in-field user; and
subsequent times that the first status change is detected, automatically and without prompting the in-field user, swapping the foreground not-on-assignment related application with the not-previously-in-foreground on-assignment related application; and
when the determining, by the electronic computing device, is that the first user speech is indicative of the second status change, responsively:
a first time in which the second status change is detected, prompting the in-field user to confirm that the foreground on-assignment related application will be swapped with the not-previously-in-foreground not-on-assignment related application; and
receiving confirmation from the in-field user; and
subsequent times that the second status change is detected, automatically and without prompting the in-field user, swapping the foreground on-assignment related application with the not-previously-in-foreground not-on-assignment related application.

18. The method of claim 1, wherein:
the on-assignment related status is a customer-service-assistance-event related status relative to a retail environment that the in-field user is currently responding to, and the not-on-assignment related status is a currently-available-to-assist-customers related status in which there is no current particular customer assistance event to which the in-field user is responding to.

19. The method of claim 18, further wherein the determining, by the electronic computing device, is that the first user speech is indicative of the first status change; and
the method further comprising swapping a foreground currently-available-to-assist-customers related application comprising one of a mapping application providing an indoor department route for the in-field user to follow indoors to ensure that his or her department is covered and visible to customers, a PTT application for speaking to a talkgroup associated with all other employees or other users of a same department or store as the in-field user, a task list setting forth one or more tasks that the in-field user may choose to perform or accept, an incident list setting forth one or more current or past security, customer, or hazardous spill incidents associated with the in-field user or an organization to which the in-field user belongs, a status indicator application setting forth a status of the in-field user and/or other users in a same organization, a contact list setting forth identities of one or more other users or other employees of a same organization to which the in-field user belongs, and a general note taking application in which the in-field user may record notes relative to the indoor department route with a not-previously-in-foreground customer-service-assistance-event-related application comprising one of an indoor mapping application providing a route for the in-field user to follow to arrive at a location at which a customer has requested assistance, a PTT application for speaking to a talkgroup associated with a particularly assigned task associated with a retail incident, a task list setting forth one or more sub-tasks associated with a particularly assigned retail task, a status indicator application setting forth a status of the in-field user and/or the other users or other persons associated with a same assigned retail task, a contact list setting forth identities of one or more other users or other employees or persons associated with a same assigned retail task, and a task-specific note taking application in which the in-field user may record notes relative to the assigned task.

20. A computing device implementing an electronic digital assistant for natural language detection of a user status change and corresponding modification of a user interface, the electronic computing device comprising:
a memory storing non-transitory computer-readable instructions;
a transceiver; and
one or more processors configured to, in response to executing the non-transitory computer-readable instructions, perform a first set of functions comprising:
monitoring one of a private voice call and a talkgroup voice call associated with an in-field user;
detect, over the one of the private voice call and the talkgroup voice call associated with the in-field user, first user speech from the in-field user;
identify a current status of the in-field user of one of an on-assignment related status and a not-on-assignment related status;
determine that the first user speech is indicative of one of (i) a first status change of the in-field user in which the current status of the in-field user is the not-on-assignment related status and the first user speech is indicative of a change to the on-assignment related status and (ii) a second status change of the in-field user in which the current status of the in-field user is the on-assignment related status and the first user speech is indicative of a change to the not-on-assignment related status; and
when the determining is that the first user speech is indicative of the first status change, responsively:
cause one of a mobile and a portable computing device associated with the in-field user to automatically and responsively swap a foreground not-on-assignment related application with a not-previously-in-foreground on-assignment related application; and
when the determining is that the first user speech is indicative of the second status change, responsively:
cause one of the mobile and the portable computing device associated with the in-field user to automatically and responsively swap a foreground on-assignment related application with a not-previously-in-foreground not-on-assignment related application.
